(19) United States
(12) Patent Application Publication
(10) Pub. No.: US 2026/0261074 A1
(43) Pub. Date: Sep. 3, 2026

(54) CONNECTOR

(71) Applicant: Yazaki Corporation, Tokyo (JP)

(72) Inventor: Takatoshi SUZUKI, Shizuoka (JP)

(73) Assignee: Yazaki Corporation, Tokyo (JP)

(21) Appl. No.: 19/552,028

(22) Filed: Feb. 27, 2026

(30) Foreign Application Priority Data
Mar. 3, 2025 (JP) 2025-032972

(51) Int. Cl. H01R 13/56; H01R 13/533; H01R 13/6581; H01R 24/22; H01R 105/00

(52) U.S. Cl. CPC H01R 13/562; H01R 13/533; H01R 13/6581; H01R 24/22; H01R 2105/00

(57) ABSTRACT

In a connector including a terminal that is electrically connected to an end portion of an electric wire and is electrically connected to a terminal portion of an electrical component, a housing that accommodates the terminal and from which the electric wire is drawn out to the outside, a shield shell that covers an outer periphery of the housing and is assembled to the electrical component, the shield shell includes a terminal shield portion that covers an outer periphery of the terminal and an electric wire shield portion that covers an outer periphery of the electric wire, and an impact mitigation portion is provided between the terminal shield portion and the electric wire shield portion, the impact mitigation portion being deformed when an impact is applied to one of the terminal shield portion and the electric wire shield portion and mitigating transmission of the impact to the other.

### CROSS-REFERENCE TO RELATED APPLICATIONS

The present application is based on, and claims priority from the prior Japanese Patent Application No. 2025-032972, filed on March 3, 2025, the entire contents of which are incorporated herein by reference.

### TECHNICAL FIELD

The present disclosure relates to a connector.

### BACKGROUND

In the related art, a connector includes a terminal that is electrically connected to an end portion of an electric wire and is electrically connected to a terminal portion of an electrical component, and a housing that accommodates the terminal and from which the electric wire is drawn out to the outside. Further, there has been known a connector including a shield shell that covers an outer periphery of a housing and is assembled to an electrical component (see JP 2012-195066 A). In the connector, the shield shell includes a first shield shell as an electric wire shield portion that covers an outer periphery of the electric wire, and a second shield shell as a terminal shield portion that covers an outer periphery of the terminal. In such a connector, the first shield shell forms a shield circuit on the outer periphery of the electric wire, and the second shield shell forms a shield circuit on the outer periphery of the terminal. By the shield shells forming the shield circuits, entry of noise or the like into the electric wire and the terminal and leakage of noise or the like from the electric wire and the terminal can be suppressed.

### SUMMARY OF THE INVENTION

Incidentally, in a connector such as that described in JP 2012-195066 A, for example, due to a collision of a vehicle or the like, in the shield shell, an impact may be applied to one of a terminal shield portion and an electric wire shield portion. Meanwhile, the impact applied to one side is transmitted to the other side, and affects an electrical connection part on the other side. For example, when an impact is applied to the electric wire shield portion, the impact is transmitted to the terminal shield portion, the terminal shield portion is deformed, and the terminal and the terminal portion of the electrical component may be exposed to the outside. When the terminal and the terminal portion of the electrical component are exposed to the outside, an electric shock or the like may be caused.

The present disclosure has been made in view of such problems in the related art. Further, an object of the present disclosure is to provide a connector capable of suppressing an influence of an impact applied to a shield shell.

A connector according to an embodiment includes a terminal that is electrically connected to an end portion of an electric wire and is electrically connected to a terminal portion of an electrical component, a housing that accommodates the terminal and from which the electric wire is drawn out to the outside, and a shield shell that covers an outer periphery of the housing and is assembled to the electrical component, wherein the shield shell includes a terminal shield portion that covers an outer periphery of the terminal and an electric wire shield portion that covers an outer periphery of the electric wire, and an impact mitigation portion is provided between the terminal shield portion and the electric wire shield portion, the impact mitigation portion being deformed when an impact is applied to one of the terminal shield portion and the electric wire shield portion and mitigating transmission of the impact to the other.

According to the present disclosure, it is possible to provide a connector capable of suppressing an influence of an impact applied to a shield shell.

### BRIEF DESCRIPTION OF DRAWINGS

FIG. 1 is a side view of a connector according to the present embodiment.

FIG. 2 is a side view illustrating a state in which an impact mitigation portion of the connector according to the present embodiment is deformed.

FIG. 3 is a perspective view of the connector according to the present embodiment.

FIG. 4 is a cross-sectional view of the connector according to the present embodiment.

FIG. 5 is an enlarged side view of the main parts of the connector according to the present embodiment.

### DETAILED DESCRIPTION OF THE INVENTION

With reference to the drawings, a connector according to the present embodiment is described below in detail. Note that the dimensional ratios in the drawings are exaggerated for explanatory purposes, and may differ from the actual ratios.

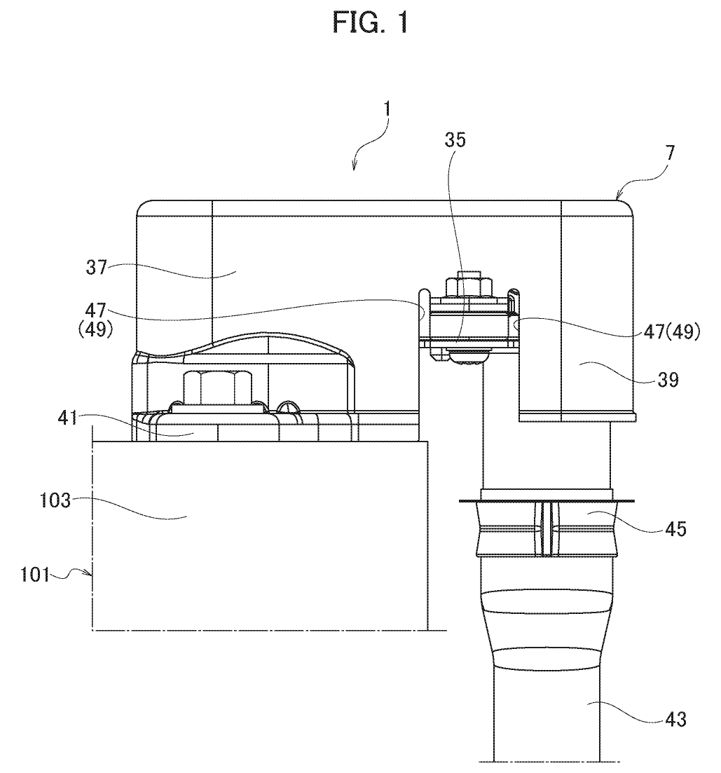

As illustrated in FIG. 1, for example, a connector 1 according to the present embodiment is electrically connected to an electrical component 101 such as an inverter of an electric motor mounted on a vehicle. In the electrical component 101, an electrical element such as a control circuit (omitted in illustration) is accommodated inside a case 103 formed of a conductive material, and a terminal portion (omitted in illustration) of the electrical element is exposed to the outside of the case 103. The connector 1 is electrically connected to a terminal portion of the electrical component 101.

As illustrated in FIG. 1 to FIG. 5, the connector 1 includes a terminal 3, a housing 5, and a shield shell 7.

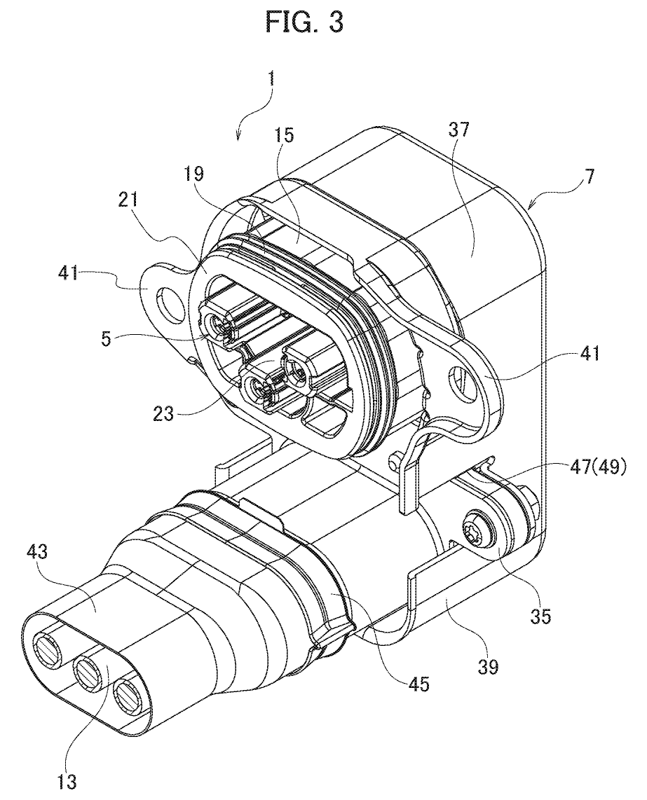

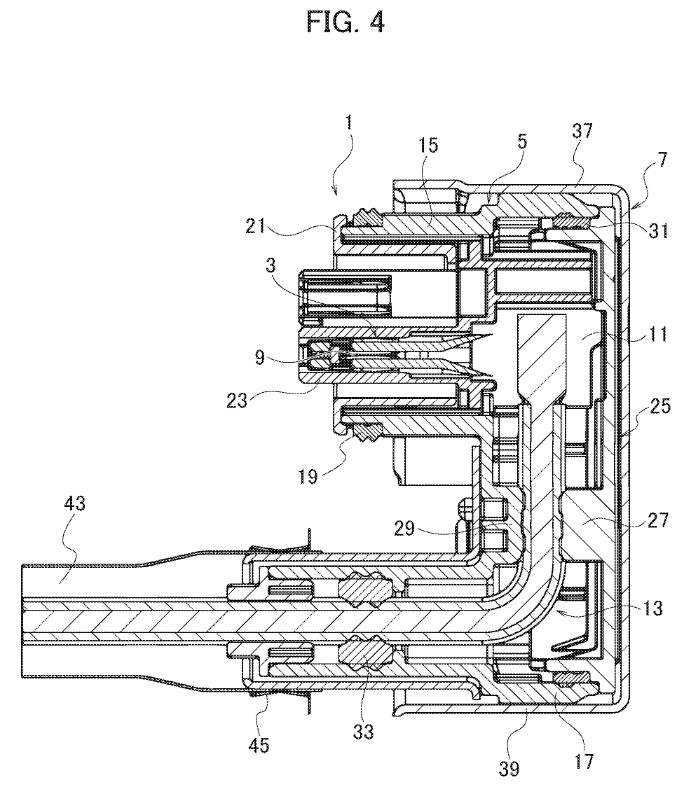

As illustrated in FIG. 3 and FIG. 4, the terminal 3 is formed of an electroconductive material, and a plurality of (in this case, three) terminals 3 are used. The terminal 3 includes an electrical connection portion 9 and an electric wire connection portion 11.

The electrical connection portion 9 is formed into a tubular shape into which the terminal portion of the electrical component 101 (see FIG. 1) can be inserted. Inside the electrical connection portion 9, a contact point portion that contacts with the terminal portion of the electrical component 101 is formed in an elastically deformable manner. When the connector 1 is fitted into the terminal portion of the electrical component 101, the terminal portion is inserted inside the electrical connection portion 9, and the contact point portion contacts with the terminal portion. The contact point portion of the electrical connection portion 9 and the terminal portion of the electrical component 101 contact with each other, and thus the electrical component 101 and the terminal 3 are electrically connected to each other.

The electric wire connection portion 11 is formed by one member continuous with the electrical connection portion 9. The electric wire connection portion 11 is formed into a case-like shape having a hole portion inside. A core wire of an electric wire 13 is fixed into the hole portion of the electric wire connection portion 11 by press-fitting or the like, and thus the terminal 3 and the electric wire 13 are electrically connected to each other.

As illustrated in FIG. 3 and FIG. 4, the electric wire 13 is formed by a covered electric wire in which an outer periphery of the core wire formed of an electroconductive material is covered with an electrical insulating coating formed of an electrical insulating material, and a plurality of (in this example, three) such wires are used. One end side of the electric wire 13 is electrically connected to another electrical component such as a power source (omitted in illustration). On the other end side of the electric wire 13, the core wire exposed from the electrical insulating coating is converted into a terminal. The part of the electric wire 13 that is converted into a terminal is inserted into the hole portion of the electric wire connection portion 11 of the terminal 3 by press-fitting or the like, and thus the terminal 3 and the electric wire 13 are electrically connected to each other. The terminal 3 provided to an end portion of the electric wire 13 is accommodated together with the electric wire 13 in the housing 5.

As illustrated in FIG. 3 and FIG. 4, the housing 5 is formed of, for example, an insulating material such as a synthetic resin. The housing 5 includes a terminal accommodation portion 15 and an electric wire accommodation portion 17.

The terminal accommodation portion 15 extends in a tubular shape along a fitting direction of the connector 1 and the terminal portion of the electrical component 101 (see FIG. 1). On an outer periphery of the terminal accommodation portion 15, a seal 19 that seals a space between the terminal accommodation portion 15 and the terminal portion of the electrical component 101 is attached. At the distal end side of the terminal accommodation portion 15, a holder 21 is assembled via an engagement portion (omitted in illustration). The holder 21 is inserted into the terminal accommodation portion 15, is arranged so as to be engaged with the seal 19, and prevents the seal 19 from coming off from the terminal accommodation portion 15. Inside the terminal accommodation portion 15, a plurality of (in this case, three) terminal accommodation chambers 23 are provided. Each of the plurality of terminal accommodation chambers 23 extend in a tubular shape along the fitting direction of the connector 1 and the terminal portion of the electrical component 101. Inside the terminal accommodation chamber 23, the electrical connection portion 9 of the terminal 3 is accommodated. An opening of the terminal accommodation chamber 23 on one side serves as a connection opening into which the terminal portion of the electrical component 101 can be inserted when the connector 1 is fitted with the terminal portion of the electrical component 101. An opening of the terminal accommodation chamber 23 on the other side serves as an insertion opening through which the electrical connection portion 9 of the terminal 3 can be inserted into the terminal accommodation chamber 23.

The electric wire accommodation portion 17 communicates with an insertion opening of the terminal accommodation chamber 23, and is formed into an L-like shape extending in a direction orthogonal to an extension direction of the terminal accommodation portion 15 and extending in a tubular shape along a direction parallel to the extension direction of the terminal accommodation portion 15. On the insertion opening side of the terminal accommodation chamber 23, the electric wire accommodation portion 17 is opened so as to accommodate the terminal 3 and the electric wire 13 inside. After the terminal 3 and the electric wire 13 are accommodated inside the electric wire accommodation portion 17, the opening of the electric wire accommodation portion 17 is closed by a cover assembled thereto via an engagement portion (omitted in illustration). The cover 25 abuts against the electric wire connection portion 11 of the terminal 3, and holds the terminal 3 to the terminal accommodation portion 15. The cover 25 is provided with an abutting portion 27 that abuts against the electric wire 13. The abutting portion 27 sandwiches the electric wire 13 between the abutting portion 27 and a protruding portion 29 that is provided to protrude inside the electric wire accommodation portion 17, and holds a state in which the electric wire 13 is bent inside the electric wire accommodation portion 17. A seal 31 that seals the inside of the housing 5 is arranged between the electric wire accommodation portion 17 and the cover 25. A waterproof plug 33 that seals the inside of the housing 5 is arranged between the electric wire accommodation portion 17 and the electric wire 13. The electric wire 13 that is drawn from the electric wire accommodation portion 17 to the outside of the housing 5 is separated from the case 103 of the electrical component 101, and is arranged along an outer surface of the case 103. An outer periphery of the housing 5 is covered with the shield shell 7.

As illustrated in FIG. 1 to FIG. 5, for example, the shield shell 7 is formed of an electroconductive material such as aluminum and iron. The shield shell 7 is formed into a case-like shape in which the housing 5 can be accommodated, and is divided into a plurality of (in this case, two) members. The shield shell 7 divided into the plurality of members is fixed integrally to the housing 5 by fastening a bolt or a nut to a plurality of (in this case, two) joining portions 35 after the housing 5 is accommodated inside. The shield shell 7 includes a terminal shield portion 37 and an electric wire shield portion 39.

At the outer periphery of the housing 5, the terminal shield portion 37 is arranged so as to cover the outer periphery of the terminal accommodation portion 15. At the terminal shield portion 37, a plurality of (in this case, two) fixing portions 41 that are fixed to the case 103 of the electrical component 101 via a bolt are provided. The fixing portion 41 is fixed to the case 103, and thus the connector 1 is fixed to the electrical component 101. Then, electrical connection between the terminal 3 and the terminal portion is maintained. In addition, the fixing portion 41 is fixed to the case 103, and thus the shield shell 7 is electrically connected to the case 103. Then, a shield circuit is formed. The terminal shield portion 37 and the case 103 in which the shield circuit is formed suppress entry of noise or the like to the terminal 3 and the terminal portion and leakage of noise or the like from the terminal 3 and the terminal portion.

At the outer periphery of the housing 5, the electric wire shield portion 39 is arranged so as to cover an outer periphery of the electric wire accommodation portion 17. On an outer periphery of the electric wire shield portion 39 on a side from which the electric wire 13 is drawn out, a shield member 43 that is formed of a braid, a metal foil, or the like and is arranged so as to cover an outer periphery of the plurality of electric wires 13 is fixed by crimping a crimping member 45. The shield member 43 is fixed to the electric wire shield portion 39, and thus is electrically connected to the shield shell 7. Then, a shield circuit is formed. The electric wire shield portion 39 and the shield member 43 in which the shield circuit is formed suppress entry of noise or the like into the electric wire 13 and leakage of noise or the like from the electric wire 13.

The shield shell 7, which is arranged on the outermost side in the connector 1, may collide with peripheral members when a vehicle collides or the like, and may receive an impact from the peripheral members. The impact from the peripheral members is easily input to any one of the terminal shield portion 37 and the electric wire shield portion 39. Meanwhile, the impact applied to one side is transmitted to the other side, and affects an electrical connection part on the other side. When an impact is applied to the terminal shield portion 37, the impact is transmitted to the electric wire shield portion 39, the electric wire 13 arranged inside the electric wire shield portion 39 may be damaged, the core wire may be exposed, and an operator may receive an electric shock or the like. When an impact is applied to the electric wire shield portion 39, the impact is transmitted to the terminal shield portion 37, the terminal 3 and the terminal portion arranged inside the terminal shield portion 37 may be exposed, and an operator may receive an electric shock or the like. In view of this, the shield shell 7 is provided with an impact mitigation portion 47 that mitigates transmission of an impact received by one side to the other side.

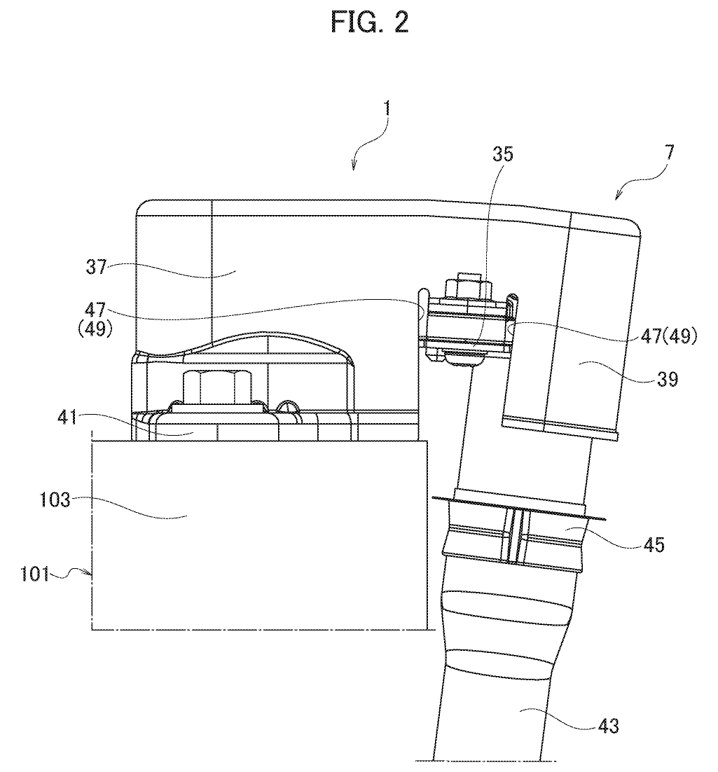

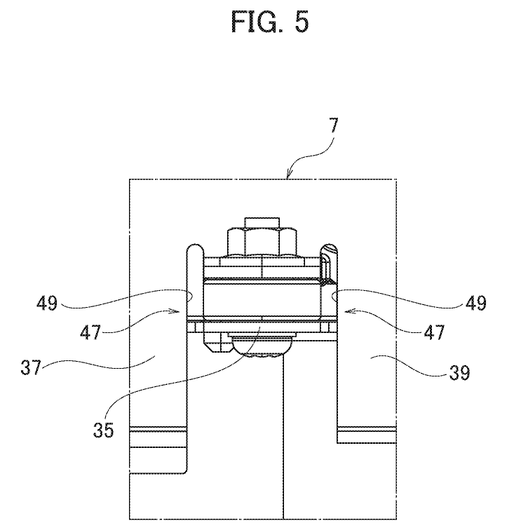

As illustrated in FIG. 1, FIG. 2, and FIG. 5, the impact mitigation portion 47 is provided to one continuous member among the plurality of divided members of the shield shell 7, and is provided between the terminal shield portion 37 and the electric wire shield portion 39. In the present embodiment, the impact mitigation portion 47 is provided in the vicinity of the joining portion 35. The impact mitigation portion 47 is a slit 49 that passes through a wall portion of the shield shell 7 and is cut out so that one side in a length direction is opened. In the present embodiment, the slit 49 is provided on each of both the sides of the joining portion 35, and a total of four slits 49 are provided.

The slit 49 as the impact mitigation portion 47 deforms the shield shell 7 when an impact is applied to one of the terminal shield portion 37 and the electric wire shield portion 39, and mitigates transmission of the impact to the other. Thus, when an impact is applied to the shield shell 7, exposure of the core wire of the electric wire 13 and exposure of the terminal 3 and the terminal portion can be suppressed, and a possibility that an operator receives an electric shock or the like can be reduced. In addition, since the slit 49 is provided as the impact mitigation portion 47, the impact mitigation portion 47 is not complicated, and the impact mitigation portion 47 can be easily provided to the shield shell 7.

As illustrated in FIG. 2, the slit 49 as the impact mitigation portion 47 is set to have such a length and a width that maintain a state in which the electric wire 13 and the electrical component 101 are separated from each other when the shield shell 7 is deformed. Thus, when an impact is applied to the shield shell 7, the electric wire 13 and the electrical component 101 do not interfere with each other, and damage or disconnection of the electric wire 13 due to interference with the electrical component 101 can be prevented. In addition, the impact mitigation portion 47 is arranged outside the side surface of the case 103 of the electrical component 101 (on a side opposite to the electrical component 101) so as to be away from the electrical component 101. By setting the impact mitigation portion 47 at a position away from the electrical component 101, interference between the electric wire 13 and the electrical component 101 can be further prevented when the shield shell 7 is deformed. Note that, when the impact mitigation portion 47 cannot be arranged at a position far away from the electrical component 101, it is only required to reduce the length and the width of the slit 49 and reduce a deformation amount of the shield shell 7, for example.

Herein, the terminal shield portion 37 and the electric wire shield portion 39 are compared with each other. Since the terminal 3 is electrically connected to the terminal portion of the electrical component 101 and the electric wire 13 is drawn out to the outside of the electrical component 101, the electric wire shield portion 39 projects more from the electrical component 101. Thus, for example, when a vehicle collides, the electric wire shield portion 39 is more likely to collide with peripheral members located around the electrical component 101. By providing the terminal shield portion 37, which is less likely to collide with peripheral members, with the fixing portion 41 to the electrical component 101, transmission of an impact from the electric wire shield portion 39 to the fixing portion 41 can be suppressed by the impact mitigation portion 47. Thus, the shield shell 7 can be stably held on the electrical component 101.

The connector 1 described above includes the terminal 3 that is electrically connected to the end portion of the electric wire 13 and is electrically connected to the terminal portion of an electrical component 101, and the housing 5 that accommodates the terminal 3 and from which the electric wire 13 is drawn out to the outside. Further, the connector 1 includes the shield shell 7 that covers the outer periphery of the housing 5 and is assembled to the electrical component 101. Further, the shield shell 7 includes the terminal shield portion 37 that covers the outer periphery of the terminal 3, and the electric wire shield portion 39 that covers the outer periphery of the electric wire 13. Further, the impact mitigation portion 47 is provided between the terminal shield portion 37 and the electric wire shield portion 39, the impact mitigation portion 47 being deformed when an impact is applied to one of the terminal shield portion 37 and the electric wire shield portion 39 and mitigating transmission of the impact to the other.

The impact mitigation portion 47 is deformed when an impact is applied to one of the terminal shield portion 37 and the electric wire shield portion 39, and mitigates transmission of the impact to the other. Thus, when an impact is applied to the shield shell 7, exposure of the core wire of the electric wire 13 and exposure of the terminal 3 and the terminal portion can be suppressed, and a possibility that an operator receives an electric shock or the like can be reduced.

Therefore, the connector 1 described above is capable of suppressing an influence of an impact applied to the shield shell 7.

Further, the impact mitigation portion 47 is the slit 49.

Thus, the impact mitigation portion 47 is not complicated, and the impact mitigation portion 47 can be easily provided to the shield shell 7.

Further, the terminal shield portion 37 is provided with the fixing portion 41 that holds the shield shell 7 to the electrical component 101.

By providing the terminal shield portion 37, which is less likely to collide with peripheral members, with the fixing portion 41 to the electrical component 101, transmission of an impact from the electric wire shield portion 39 to the fixing portion 41 can be suppressed by the impact mitigation portion 47. Thus, the shield shell 7 can be stably held on the electrical component 101.

Further, the impact mitigation portion 47 maintains a state in which the electric wire 13 and the electrical component 101 are separated from each other at the time of deformation.

Thus, when an impact is applied to the shield shell 7, the electric wire 13 and the electrical component 101 do not interfere with each other, and damage or disconnection of the electric wire 13 due to interference with the electrical component 101 can be prevented.

While the present embodiment is described above, the present embodiment is not limited thereto, and various modifications may be made within the gist of the present embodiment.

For example, the impact mitigation portion is provided as the slit, but is not limited thereto. For example, an elastic member such as rubber that is elastically deformable may be arranged between the terminal shield portion and the electric wire shield portion to serve as the impact mitigation portion. As long as the impact mitigation portion mitigates transmission of an impact by deformation, any configuration may be employed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a terminal that is electrically connected to an end portion of an electric wire and is electrically connected to a terminal portion of an electrical component;
a housing that accommodates the terminal and from which the electric wire is drawn out to the outside; and
a shield shell that covers an outer periphery of the housing and is assembled to the electrical component, wherein
the shield shell includes a terminal shield portion that covers an outer periphery of the terminal and an electric wire shield portion that covers an outer periphery of the electric wire, and
an impact mitigation portion is provided between the terminal shield portion and the electric wire shield portion, the impact mitigation portion being deformed when an impact is applied to one of the terminal shield portion and the electric wire shield portion and mitigating transmission of the impact to the other.

2. The connector according to claim 1, wherein
the impact mitigation portion is a slit.

3. The connector according to claim 1, wherein
the terminal shield portion is provided with a fixing portion that holds the shield shell to the electrical component.

4. The connector according to claim 1, wherein
the impact mitigation portion maintains a state in which the electric wire and the electrical component are separated away from each other at the time of deformation.
